(19) United States
(12) Patent Application Publication
(10) Pub. No.: US 2016/0075898 A1
(43) Pub. Date: Mar. 17, 2016

(54) IMAGE RECORDING METHOD AND INK SET

(71) Applicant: CANON KABUSHIKI KAISHA, Tokyo (JP)

(72) Inventors: Takashi Imai, Kawasaki-shi (JP); Mamiko Kaji, Kawasaki-shi (JP)

(21) Appl. No.: 14/836,150

(22) Filed: Aug. 26, 2015

(30) Foreign Application Priority Data
Sep. 17, 2014 (JP) 2014-188875

(51) Int. Cl. C09D 11/54; B41J 2/21

(52) U.S. Cl. CPC C09D 11/54; B41J 2/2107

(57) ABSTRACT

Provided is an image recording method including a step (A) of applying an ink containing a coloring material to a recording medium and a step (B) of applying to the recording medium a liquid composition that causes viscosity increase when mixed with the ink so as to at least partially overlap with an area where the ink is applied. The ink contains resin particles, an anionic water-soluble resin, and an anionic surfactant having a carboxy group, the content of the surfactant in the ink is 1% by mass or more and 8% by mass or less based on the total mass of the ink, and the mass ratio of the content of the water-soluble resin to the content of the surfactant in the ink is 0.3 or more and 5.0 or less.

### BACKGROUND OF THE INVENTION

1. Field of the Invention

The present invention relates to an image recording method and an ink set.

2. Description of the Related Art

In conventional ink jet image recording methods, a method of applying an ink and a reaction solution to a recording medium to record images (hereinafter called “two-liquid reaction system”) has been developed as an image recording method capable of recording high-quality images at high speeds. The reaction solution used in the method is a liquid composition that causes an increase in viscosity of an ink when coming in contact with the ink.

When such a two-liquid reaction system is used to record images at high speeds, a coloring material can move on the image after the recording (after image formation) to leave color skip areas, causing the phenomenon of reducing the image quality in some cases (hereinafter called “image shift”). As the means for suppressing such an image shift, methods of recording images by using an ink containing a pigment, resin particles, and a surfactant and a reactant containing a coagulant that causes aggregation of the components in the ink are disclosed in Japanese Patent Application Laid-Open No. 2010-31267, Japanese Patent Application Laid-Open No. 2010-241049, and Japanese Patent Application Laid-Open No. 2011-63001.

In the ink jet image recording methods, a system of applying a clear ink on an image has been also studied. Japanese Patent Application Laid-Open No. 2004-181803 discloses an image recording method using a clear ink containing a resin, and teaches that the image recording method can give images with good glossiness and the like.

### SUMMARY OF THE INVENTION

According to one aspect of the present invention, there is provided an image recording method including a step (A) of applying an ink containing a coloring material to a recording medium and a step (B) of applying a liquid composition to the recording medium so as to at least partially overlap with an area where the ink is applied, the liquid composition causing viscosity increase when mixed with the ink. In the image recording method, the ink contains resin particles, an anionic water-soluble resin, and an anionic surfactant having a carboxy group, the content of the surfactant in the ink is 1% by mass or more and 8% by mass or less based on the total mass of the ink, and the mass ratio of the content of the water-soluble resin to the content of the surfactant in the ink is 0.3 times or more and 5.0 times or less.

According to another aspect of the present invention, there is provided an image recording method including a step (A) of applying an ink containing a coloring material to a recording medium, a step (B) of applying a liquid composition to the recording medium so as to at least partially overlap with an area where the ink is applied, the liquid composition causing viscosity increase when mixed with the ink, and a step (C) of applying a clear ink containing no coloring material to the recording medium so as to at least partially overlap with an area where the liquid composition is applied. In the image recording method, the clear ink contains an anionic water-soluble resin and an anionic surfactant having a carboxy group.

Further features of the present invention will become apparent from the following description of exemplary embodiments.

### DESCRIPTION OF THE EMBODIMENTS

The inventors of the present invention have studied the techniques disclosed in Japanese Patent Application Laid-Open No. 2010-31267, Japanese Patent Application Laid-Open No. 2010-241049, and Japanese Patent Application Laid-Open No. 2011-63001, and have found that when the technique is used to eject an ink particularly at a high speed and a high injection amount, the recorded images cause a variation in the dot size and an image shift.

In addition, when high speed recording is carried out by using the image recording method of applying a clear ink, disclosed in Japanese Patent Application Laid-Open No. 2004-181803, on an image formed by the two-liquid reaction system using an ink and a liquid composition, smeared images and image cracks are generated on some images, and a high-quality image cannot be obtained in some cases.

Thus, the present invention is directed to providing an image recording method that causes no variation in dot size or no image shift on images and enables recording of high-quality images even when the two-liquid reaction system is used and an ink is ejected at a high injection amount and a high speed.

The present invention is directed to providing an image recording method that causes no smeared images or image cracks on images and enables recording of high-quality images even when the two-liquid reaction system is used and a clear ink is used to record images at a high speed.

The present invention will now be described in detail with reference to preferred embodiments. In the below description, “(meth)acrylic acid” and “(meth)acrylate” mean “acrylic acid, methacrylic acid” and “acrylate, methacrylate”, respectively.

When the two-liquid reaction system is used to particularly carry out high speed recording, each color ink is required to have high-speed aggregating properties. Here, the “high-speed aggregating properties” mean that an ink immediately causes viscosity increase to aggregate. If inks have insufficient high-speed aggregating properties, the inks interfere with each other in an area where ink dots overlap with each other. When inks interfere with each other in an area where ink dots overlap with each other, such a phenomenon occurs that a dot of a second color ink overlappingly applied on a dot of a first color ink that has been applied has a larger dot size or a smaller dot size. In other words, the dot size of an ink varies in formed images, and image recording cannot be controlled unfortunately. To solve such a problem, each ink is required to have high-speed aggregating properties.

In addition, when high speed recording is carried out by using the two-liquid reaction system and using a clear ink, the clear ink is also required to have high-speed aggregating properties. If a clear ink has insufficient high-speed aggregating properties, the clear ink interfere with each other in an area where clear ink dots overlap with each other, and smeared images are generated on images. To solve such a problem, the clear ink is required to have high-speed aggregating properties.

As a result of intensive studies, however, the inventors of the present invention have found that when the ink or the clear ink has higher high-speed aggregating properties, a coloring material shifts on a recording medium or between ink layers after recording to cause image shifts. Such an image shift is supposed to be caused by volumetric shrinkage of the ink or the clear ink due to the aggregation of the ink or the clear ink. In order to record high-quality images at high speeds, it is thus essential that the ink or the clear ink have both the high-speed aggregating properties and the effect of suppressing image shifts.

The inventors have thus carried out further studies and consequently have found that addition of an anionic water-soluble resin and an anionic surfactant at a particular ratio to an ink or a clear ink enables the ink or the clear ink to have both the high-speed aggregating properties and the effect of suppressing image shifts. This is supposed to be achieved by coexistence of the water-soluble resin that exhibits viscosity increase action when coming in contact with the liquid composition and the surfactant that becomes hydrophobic when coming in contact with the liquid composition and is likely to be incorporated in aggregates of the water-soluble resin, at a particular ratio.

In the image recording method of the present invention, if the content of the surfactant is less than 1% by mass in the ink, the ink or the clear ink has an insufficient effect of suppressing volumetric shrinkage, causing image cracks. In the image recording method of the present invention, if the content of the surfactant is more than 8% by mass in the ink, such an ink has insufficient aggregating properties to cause a problem of variation in dot size of ink dots, and such a clear ink causes a problem of smeared images.

If the mass ratio of the content of the water-soluble resin to the content of the surfactant in the ink is less than 0.3 times ([the content of the water-soluble resin]/[the content of the surfactant]<0.3), the effect of suppressing ink shrinkage becomes insufficient, causing image cracks. If the mass ratio of the content of the water-soluble resin to the content of the surfactant in the ink is more than 5 times ([the content of the water-soluble resin]/[the content of the surfactant]>5), the water-soluble resin has insufficient aggregating properties, causing a variation in the dot size of ink dots. Such a clear ink causes a problem of smeared images.

The image recording method of the present invention enables recording of images with excellent image quality even when an ink is ejected at a high speed and a high injection amount. The term “high speed” means that the impact time difference from the impact of one ink on a recording medium until the impact of another ink on the recording medium is short, and specifically means that the impact time difference is 0.2 second or less. In the image recording method of the present invention, the impact time difference can be 0.05 second or less. The term “high injection amount” means that the amount of an ink applied to a recording medium is large, and specifically means that the amount applied is 15 g/m² or more. In the image recording method of the present invention, the amount applied can be 20 g/m² or more.

### Image Recording Method

### First Embodiment

A first embodiment of the image recording method of the present invention includes a step (A) of applying an ink to a recording medium and a step (B) of applying a liquid composition to the recording medium so as to at least partially overlap with an area where the ink is applied.

In the present invention, the step (A) and the step (B) can be performed in any order. For example, after the step (A), the step (B) can be performed, or after the step (B), the step (A) can be performed.

The same step can be performed twice or more.

In particular, a method including a process of performing the step (A) after the step (B) produces a larger effect of improving image quality and thus is more preferred.

Step (A)

The step (A) is a step of applying an ink containing a coloring material to a recording medium. The ink can contain an aqueous medium and other components in addition to the coloring material.

Coloring Material

In the present invention, the ink is not limited to particular inks, and can be a cyan ink, a magenta ink, a yellow ink, a black ink, and other inks. The coloring materials contained in the inks can be known dyes or pigments. These coloring materials can be used singly or in combination of two or more of them.

In the present invention, the pigment can be any of the conventionally known pigments. The content (% by mass) of the pigment is preferably 0.2% by mass or more and 15.0% by mass or less and more preferably 0.6% by mass or more and 10.0% by mass or less based on the total mass of the ink.

In the present invention, the pigment is exemplified by resin-dispersion type pigments containing a resin as a dispersant and self-dispersion type pigments (self-dispersible pigment) in which hydrophilic groups are introduced onto the surface of pigment particles, which are classified in terms of dispersion methods. Examples of the resin-dispersion type pigment include resin dispersed pigments containing a resin dispersant, microcapsule pigments in which the surface of pigment particles is covered with a resin, and resin-bonded pigments in which an organic group containing a resin is chemically bonded to the surface of pigment particles. Pigments with different dispersion methods can naturally be used in combination. Carbon black or an organic pigment is preferably used as a specific pigment. These pigments can be used singly or in combination of two or more of them.

When the pigment used in the ink is the resin-dispersion type pigment, a resin is used as a dispersant.

The resin used as the dispersant preferably has both a hydrophilic moiety and a hydrophobic moiety. Specific examples of the resin include acrylic resins prepared by polymerization of a monomer having a carboxy group, such as acrylic acid and methacrylic acid; and urethane resins prepared by polymerization of a diol having an anionic group, such as dimethylolpropionic acid.

The resin used as the dispersant preferably has an acid value of 40 mg KOH/g or more and 500 mg KOH/g or less. The resin used as the dispersant preferably has a weight average molecular weight (Mw) of 1,000 or more and 50,000 or less that is determined by GPC in terms of polystyrene.

The content (% by mass) of the resin dispersant in the ink is preferably 0.1% by mass or more and 10.0% by mass or less and more preferably 0.2% by mass or more and 4.0% by mass or less based on the total mass of the ink. The mass ratio of the content (% by mass) of the resin dispersant to the content (% by mass) of the pigment is preferably 0.1 times or more and 3.0 times or less.

The dye used in the present invention is exemplified by dyes having hues such as black, cyan, magenta, and yellow. The dye may be any of the acid dyes, the direct dyes, the basic dyes, and the disperse dyes described in the COLOUR INDEX. The content (% by mass) of the dye is preferably 1% by mass or more and 20% by mass or less and more preferably 2% by mass or more and 12% by mass or less based on the total mass of the ink.

Resin Particles

In the present invention, the term “resin particles” mean a resin present in the state of particles having a particle size and dispersed in a solvent. In the present invention, the resin particles preferably have a 50% cumulative volume average particle diameter (D₅₀) of 10 nm or more and 1,000 nm or less and more preferably 40 nm or more and 500 nm or less. In the present invention, the D₅₀ of resin particles is determined in the following procedure. A resin particle dispersion is diluted 50 times (in terms of volume) with pure water, and the diluted dispersion is subjected to measurement with an UPA-EX150 (manufactured by NIKKISO CO., LTD.) under measurement conditions of a SetZero of 30 s, a number of measurements of three times, a measurement time of 180 seconds, and a refractive index of 1.5.

The resin particles preferably have a weight average molecular weight of 1,000 or more and 2,000,000 or less that is determined by gel permeation chromatography (GPC) in terms of polystyrene.

In the image recording method of the present invention, the content (% by mass) of the resin particles in the ink is preferably 3% by mass or more and 20% by mass or less based on the total mass of the ink. The content of the resin particles in the ink is more preferably 3% by mass or more and 15% by mass or less and even more preferably 5% by mass or more and 10% by mass or less.

In the image recording method of the present invention, the mass ratio of the content (% by mass) of the resin particles in the ink to the content (% by mass) of the pigment based on the total mass of the ink is preferably 0.2 times or more and 100 times or less.

In the present invention, any of the resin particles satisfying the above definition of the resin particles can be used in the ink. As a monomer usable for the resin particles, any of the monomers polymerizable by emulsion polymerization, suspension polymerization, dispersion polymerization, or a similar method can be used. Examples of the resin particles include acrylic resin particles, vinyl acetate resin particles, ester resin particles, ethylene resin particles, urethane resin particles, synthetic rubber particles, vinyl chloride resin particles, vinylidene chloride resin particles, and olefinic resin particles, which are classified in terms of the difference in monomer. Among them, acrylic resin particles or urethane resin particles are preferably used. In the present invention, the resin particles are preferably anionic resin particles.

Examples of the monomer specifically usable for the acrylic resin particles include α,β-unsaturated carboxylic acids such as (meth)acrylic acid, maleic acid, crotonic acid, angelic acid, itaconic acid, and fumaric acid and salts thereof; ester compounds of α,β-unsaturated carboxylic acids, such as ethyl (meth)acrylate, methyl (meth)acrylate, butyl (meth)acrylate, methoxyethyl (meth)acrylate, ethoxyethyl (meth)acrylate, diethylene glycol (meth)acrylate, trlethylene glycol (meth)acrylate, tetraethylene glycol (meth)acrylate, polyethylene glycol (meth)acrylate, methoxydiethylene glycol (meth)acrylate, methoxytriethylene glycol (meth)acrylate, methoxytetraethylene glycol (meth)acrylate, methoxypolyethylene glycol (meth)acrylate, cyclohexyl (meth)acrylate, isobornyl (meth)acrylate, N,N-dimethylaminopropyl (meth)acrylate, monobutyl maleate, and dimethyl itaconate; alkyl amide compounds of α,β-unsaturated carboxylic acids, such as (meth)acrylamide, dimethyl(meth)acrylamide, N,N-dimethylethyl(meth)acrylamide, N,N-dimethylpropyl(meth)acrylamide, isopropyl(meth)acrylamide, diethyl(meth)acrylamide, (meth)acryloylmorpholine, maleic acid monoamide, and crotonic acid methylamide; α,β-ethylenically unsaturated compounds having an aryl group, such as styrene, α-methylstyrene, vinyl phenylacetate, benzyl (meth)acrylate, and 2-phenoxyethyl (meth)acrylate; and ester compounds of polyfunctional alcohols, such as ethylene glycol diacrylate and polypropylene glycol dimethacrylate.

Such an acrylic resin may be a homopolymer prepared by polymerization of a single monomer or a copolymer prepared by polymerization of two or more monomers. When the resin particles are a copolymer, the copolymer may be a random copolymer or a block copolymer. Specifically preferred are resin particles prepared by using hydrophilic monomers and hydrophobic monomers. The hydrophilic monomer is exemplified by α,β-unsaturated carboxylic acids and salts thereof, and the hydrophobic monomer is exemplified by ester compounds of α,β-unsaturated carboxylic acids and α,β-ethylenically unsaturated compounds having an aryl group.

The urethane resin particles are resin particles synthesized by reacting a polyisocyanate that is a compound having two or more isocyanate groups with a polyol compound which is a compound having two or more hydroxy groups. In the present invention, any of the urethane resin particles that are prepared by reacting a known polyisocyanate compound with a known polyol compound can be used as long as the requirements for the resin particles are satisfied.

Examples of the resin particles include resin particles having a single layer structure and resin particles having a multi-layered structure such as a core-shell structure, which are classified in terms of structure. In the present invention, resin particles having a multi-layered structure are preferably used. In particular, resin particles having a core-shell structure are more preferably used. When resin particles have a core-shell structure, the core part and the shell part function in clearly different ways. Resin particles having such a core-shell structure have an advantage of capable of imparting more functions to an ink than resin particles having a single layer structure.

Water-Soluble Resin

The water-soluble resin used in the present invention is an anionic water-soluble resin and has an anionic group. The anionic group is exemplified by a carboxy group (—COOH), a sulfonic acid group (—SO₃H), and a phosphate group (—PO₄H). The anionic water-soluble resin having an anionic group can be prepared by polymerizing a monomer having an anionic group or by reacting a resin having a functional group that can be converted into an anionic group to convert the functional group into the anionic group.

The anionic monomer is not limited to particular types. As the monomer having a carboxy group, unsaturated carboxylic acids such as acrylic acid, methacrylic acid, and maleic acid can be used. As the monomer having a sulfonic acid group, styrenesulfonic acid or vinylsulfonic acid can be used, for example. As the monomer having a phosphoric acid group, vinylphosphonic acid can be used, for example. Among these monomers, the monomer having a carboxy group is preferably used. In other words, the water-soluble resin preferably has a constituent unit derived from an unsaturated carboxylic acid.

The water-soluble resin used in the present invention preferably has a hydrophobic group in combination with the anionic group. The hydrophobic group is exemplified by groups having an aromatic ring (a phenyl group or a benzyl group, for example). This is because control of the ratio between the anionic group and the hydrophobic group enables control of the reactivity between the water-soluble resin and the liquid composition. The water-soluble resin having an anionic group and a hydrophobic group can be prepared by copolymerizing a hydrophobic monomer with an anionic monomer. The hydrophobic monomer is not limited to particular types, and known hydrophobic monomers such as styrene, styrene derivatives, benzyl acrylate, and benzyl methacrylate can be used.

The water-soluble resin used in the present invention preferably has an acid value of 40 mg KOH/g or more and 500 mg KOH/g or less. The acid value is more preferably 40 mg KOH/g or more and 90 mg KOH/g or less and particularly preferably 40 mg KOH/g or more and 70 mg KOH/g or less. The water-soluble resin preferably has a weight average molecular weight of 1,000 or more and 50,000 or less. The water-soluble resin preferably has a polydispersity (ratio of weight average molecular weight Mw to number average molecular weight Mn, Mw/Mn) of 1.0 or more and 3.0 or less.

The water-soluble resin is preferably added to the ink in a salt form prepared in such a way that a pH adjuster is added to an aqueous solution of the resin prepared by polymerization of the monomer to adjust the pH of the aqueous solution to 7 to 10. Specific examples of the pH adjuster include various organic amines such as monoethanolamine, diethanolamine, and triethanolamine; and inorganic alkaline agents such as hydroxides of alkali metals, including sodium hydroxide, lithium hydroxide, and potassium hydroxide.

The content of the water-soluble resin in the ink is preferably 0.3% by mass or more and 40.0% by mass or less in terms of solid content based on the total mass of the ink. When the water-soluble resin (anionic water-soluble resin) is used as a pigment dispersant, the pigment dispersant is also included in “the water-soluble resin in the ink”. In other words, “the content of the water-soluble resin in the ink” is required to be calculated from the sum of the amount of the water-soluble resin added to prepare the ink and the amount of the water-soluble resin as the pigment dispersant.

In the present specification, the term “water-soluble resin” means a resin having a solubility of 1 g/L or more in water at 25° C.

Any water-soluble resins independently added and any water-soluble resins derived from the pigment dispersion are considered to be included in “water-soluble resin” as long as they are contained “in the ink”.

Surfactant

The surfactant contained in the ink is an anionic surfactant having a carboxy group. Such a surfactant highly interacts with the water-soluble resin when coming in contact with a liquid composition. On this account, such a surfactant is readily incorporated in aggregates formed by aggregation of the water-soluble resin that has come in contact with the liquid composition and can effectively suppress image shifts. Specific examples of the surfactant includes potassium laurate, sodium laurate, potassium oleate, sodium oleate, and dipotassium alkenyl succinate (trade name “LATEMUL ASK”, manufactured by Kao Co.). Anionic surfactants having a plurality of carboxy groups, such as dipotassium alkenyl succinate, can more effectively suppress image shifts and thus are preferred.

The content of the surfactant in the ink is 1% by mass or more and 8% by mass or less and preferably 2% by mass or more and 8% by mass or less based on the total mass of the ink. The mass ratio of the content of the water-soluble resin to the content of the surfactant in the ink is 0.3 times or more and 5.0 times or less and preferably 0.5 times or more and 3.0 times or less. A surfactant other than the above-mentioned surfactant can be further contained in the ink in order to adjust the surface tension of the ink, for example.

Aqueous Medium

The ink used in the present invention can contain an aqueous medium that is water or a mixed solvent of water and a water-soluble organic solvent. The content (% by mass) of the water-soluble organic solvent is preferably 1.0% by mass or more and 50.0% by mass or less based on the total mass of the ink. As the water-soluble organic solvent, any of the conventionally, generally used water-soluble organic solvents can be used. Examples of the water-soluble organic solvent include alcohols, glycols, alkylene glycols having an alkylene group with 2 to 6 carbon atoms, polyethylene glycols, nitrogen-containing compounds, and sulfur-containing compounds. These water-soluble organic solvents can be used singly or in combination of two or more of them, as necessary. As the water, deionized water (ion-exchanged water) is preferably used. The content (% by mass) of the water is preferably 30.0% by mass or more and 95.0% by mass or less based on the total mass of the ink.

Other Components

The ink used in the present invention can contain various components, as necessary, in addition to the above-mentioned components. The ink can contain water-soluble organic compounds that are solid at normal temperature, including polyhydric alcohols such as trimethylolpropane and trimethylolethane and urea derivatives such as urea and ethylene urea. The ink can further contain various additives such as nonionic water-soluble resins, surfactants, pH adjusters, anticorrosives, antiseptic agents, antifungal agents, antioxidants, reduction inhibitors, evaporation accelerators, chelating agents, and resins other than the above resin particles, as necessary.

Application Method

In the present invention, the method of applying ink to a recording medium is preferably an ink jet recording method including a step of ejecting an ink from an ink jet recording head in response to recording signals to perform recording on a recording medium. Particularly preferred is an ink jet recording method in which thermal energy is applied to an ink and the ink is ejected from an ejection orifice of a recording head. The term “recording” in the present invention includes recording on permeable recording media such as glossy paper and plain paper and printing on non-permeable recording media such as glass plates, plastic plates, and plastic films.

Step (B)

The step (B) is a step of applying a liquid composition that causes viscosity increase when mixed with the ink to the recording medium so as to at least partially overlap with an area where the ink is applied. The liquid composition can contain a reactant, an aqueous medium, and other components.

The liquid composition used in the present invention is a composition that causes viscosity increase when mixed with the ink. The liquid composition is preferably colorless, milky white, or white so as not to affect an image recorded with the ink. On this account, the ratio of a maximum absorbance to a minimum absorbance (maximum absorbance/minimum absorbance) in a wavelength region from 400 nm to 800 nm, which is the wavelength region of visible light, is preferably 1.0 or more and 2.0 or less. This means that the liquid composition has substantially no absorbance peak in the visible light wavelength region, or that if the liquid composition has a peak, the intensity of the peak is extremely small. In addition, the liquid composition preferably contains no coloring material. The absorbance can be determined by using an undiluted liquid composition with a Hitachi double beam spectrophotometer, U-2900 (manufactured by Hitachi High-Technologies Corporation). In the measurement, the liquid composition can be diluted and subjected to absorbance measurement. This is because both the maximum absorbance and the minimum absorbance of a liquid composition are proportional to a dilution ratio and thus the rate of the maximum absorbance to the minimum absorbance (maximum absorbance/minimum absorbance) does not depend on a dilution rate.

Reactant

The liquid composition used in the present invention can contain a reactant that causes an increase in viscosity of an ink when coming in contact with the ink. The reactant may be a conventionally known compound. Specifically, at least one substance selected from polyvalent metal ions and organic acids is preferably used. A plurality of types of reactants are also preferably contained in the liquid composition.

Specific examples of the polyvalent metal ion include divalent metal ions such as Ca²⁺, Cu²⁺, Ni²⁺, Mg²⁺, Sr²⁺, Ba²⁺, and Zn²⁺; and trivalent metal ions such as Fe³⁺, Cr³⁺, Y³⁺, and Al³⁺. In the present invention, the polyvalent metal ion can be added to the liquid composition in a salt form such as hydroxides and chlorides, which are dissociated to form those ions. In the present invention, the content (% by mass) of the polyvalent metal ion is preferably 3% by mass or more and 90% by mass or less based on the total mass of the liquid composition.

Specific examples of the organic acid include oxalic acid, polyacrylic acid, formic acid, acetic acid, propionic acid, glycolic acid, malonic acid, malic acid, maleic acid, ascorbic acid, levulinic acid, succinic acid, glutaric acid, glutamic acid, fumaric acid, citric acid, tartaric acid, lactic acid, pyrrolidonecarboxylic acid, pyronecarboxylic acid, pyrrolecarboxylic acid, furancarboxylic acid, pyridinecarboxylic acid, coumaric acid, thiophenecarboxylic acid, nicotinic acid, oxysuccinic acid, and dioxysuccinic acid. In the present invention, the content (% by mass) of the organic acid is preferably 3% by mass or more and 99% by mass or less based on the total mass of the liquid composition.

Aqueous Medium

The liquid composition used in the present invention can contain an aqueous medium that is water or a mixed solvent of water and a water-soluble organic solvent. The content (% by mass) of the water-soluble organic solvent is preferably 3.0% by mass or more and 50.0% by mass or less based on the total mass of the liquid composition. As the water-soluble organic solvent, any of the conventionally, generally used water-soluble organic solvents can be used. Examples of the water-soluble organic solvent include alcohols, glycols, alkylene glycols having an alkylene group with 2 to 6 carbon atoms, polyethylene glycols, nitrogen-containing compounds, and sulfur-containing compounds. These water-soluble organic solvents can be used singly or in combination of two or more of them, as necessary. As the water, deionized water (ion-exchanged water) is preferably used. The content (% by mass) of the water is preferably 50.0% by mass or more and 95.0% by mass or less based on the total mass of the liquid composition.

Other Components

The liquid composition used in the present invention can also contain water-soluble organic compounds that are solid at normal temperature, including polyhydric alcohols such as trimethylolpropane and trimethylolethane and urea derivatives such as urea and ethylene urea, as necessary, in addition to the above-mentioned components. The liquid composition of the present invention can further contain various additives such as surfactants, pH adjusters, anticorrosives, antiseptic agents, antifungal agents, antioxidants, reduction inhibitors, evaporation accelerators, chelating agents, and resins, as necessary.

Application Method

In the present invention, the liquid composition is applied to the recording medium so as to at least partially overlap with an area where the ink is applied. The area where the ink is applied includes an area where the ink has been applied and an area where the ink is not applied yet but the liquid composition is applied and then the ink is to be applied. The condition “so as to at least partially overlap” means that an area where the ink is applied partially or wholly overlaps with an area where the liquid composition is applied.

In the present invention, the method of applying the liquid composition to the recording medium is exemplified by application by coating in addition to the application by ink jetting described above. The coating is exemplified by roller coating, bar coating, and spray coating.

Ink Set

The ink set of the present invention is an ink set including an ink containing a coloring material and a liquid composition that causes viscosity increase when mixed with the ink. The ink also contains resin particles, an anionic water-soluble resin, and an anionic surfactant having a carboxy group. The content of the surfactant in the ink is 1% by mass or more and 8% by mass or less based on the total mass of the ink. The mass ratio of the content of the water-soluble resin to the content of the surfactant in the ink is 0.3 times or more and 5.0 times or less.

In the ink set of the present invention, the specific components of the ink and the liquid composition and the formulations thereof are the same as those described above regarding the image recording method. The ink set of the present invention can be suitably used in the image recording method of the present invention.

### Image Recording Method

### Second Embodiment

A second embodiment of the image recording method of the present invention includes a step (A) of applying an ink to a recording medium, a step (B) of applying a liquid composition that causes viscosity increase when mixed with the ink to the recording medium, and a step (C) of applying a clear ink containing no coloring material to the recording medium.

In the second embodiment, the step (A), the step (B), and the step (C) can be performed in any order. For example, after the step (A), the step (B) can be performed, and then the step (C) can be performed. Alternatively, after the step (C), the step (B) can be performed, and then the step (A) can be performed.

The same step can be performed twice or more. For example, the method can be carried out in the order of the step (A), the step (B), the step (A), and the step (C) or can be carried out in the order of the step (B), the step (A), the step (C), the step (A), and the step (C).

In particular, a method including a process of performing the step (A) after the step (B) and then performing the step (C) produces a larger effect of improving image quality and thus is more preferred.

Step (A), Step (B)

The step (A) is a step of applying an ink containing a coloring material to a recording medium. The step (B) is a step of applying a liquid composition that causes viscosity increase when mixed with the ink to the recording medium so as to at least partially overlap with an area where the ink is applied.

In the second embodiment, the step (A) and the step (B) can be performed in the same manner as in the first embodiment.

The second embodiment is characterized by the formulation of the clear ink, and the formulation of the ink used in the step (A) is not limited to particular formulations. In other words, the ink does not necessarily contain resin particles, an anionic water-soluble resin, or an anionic surfactant having a carboxy group. However, an ink having a formulation similar to that in the first embodiment is also preferably used in the second embodiment.

Step (C)

The step (C) is a step of applying a clear ink containing no coloring material to the recording medium so as to at least partially overlap with an area where the liquid composition is applied. When the step (C) is performed, the glossiness of images is improved.

Water-Soluble Resin, Surfactant

The clear ink is a clear ink that contains substantially no coloring material but contains an anionic water-soluble resin and an anionic surfactant having a carboxy group. As the water-soluble resin and the surfactant, the same substances for the ink used in the step (A) can be used. In the second embodiment, the content of the surfactant in the clear ink is preferably 1% by mass or more and 8% by mass or less based on the total mass of the clear ink. In the second embodiment, when the mass ratio of the content of the water-soluble resin to the content of the surfactant in the clear ink is 0.3 times or more and 10.0 times or less, the advantageous effect of the invention can be achieved.

Aqueous Medium

The clear ink can contain an aqueous medium that is water or a mixed solvent of water and a water-soluble organic solvent. The types and the contents of material components of the aqueous medium are the same as those of the aqueous medium in the ink used in the step (A).

Other Components

The clear ink can contain various components, as necessary, in addition to the above-mentioned components. The types and the contents of these material components are the same as those of other components used in the step (A).

Application Method

In the step (C), the clear ink is applied to the recording medium so as to at least partially overlap with an area where the liquid composition is applied. The area where the liquid composition is applied includes an area where the liquid composition has been applied and an area where the liquid composition is not applied yet but the clear ink is applied and then the liquid composition is to be applied. The condition “so as to at least partially overlap” means that an area where the liquid composition is applied partially or wholly overlaps with an area where the clear ink is applied. In the present invention, the clear ink is preferably applied to the recording medium so as to at least partially overlap with an area where the ink is applied.

Ink Set

The ink set of the present invention is an ink set including an ink containing a coloring material, a clear ink containing no coloring material, and a liquid composition that causes viscosity increase when mixed with the ink and the clear ink. The clear ink contains an anionic water-soluble resin and an anionic surfactant having a carboxy group.

In the ink set of the present invention, the specific components of the ink, the clear ink, and the liquid composition and the formulations thereof are the same as those described above regarding the image recording method. The ink set of the present invention can be suitably used in the image recording method of the present invention.

### EXAMPLES

The present invention will next be described in further detail with reference to examples and comparative examples. The present invention is not intended to be limited to the following examples without departing from the scope of the invention. In the following description in examples, “part” is based on mass unless otherwise noted.

Water-Soluble Resin

As the water-soluble resins to be added to inks or clear inks, the aqueous water-soluble resin solutions 1 to 3 shown in Table 1 were used. The aqueous water-soluble resin solutions 1 to 4 shown in Table 1 are aqueous resin solutions prepared by neutralizing a styrene-butyl acrylate-acrylic acid copolymer with potassium hydroxide (neutralizer) and adjusting the solid content of the aqueous solution to a predetermined value. These aqueous resin solutions differ from each other in the acid value and the weight average molecular weight of the water-soluble resin, the solid content of the aqueous resin solution, and whether the aqueous resin solution contains 2-pyrrolidone or not. The aqueous water-soluble resin solution 4 shown in Table 1 was used to prepare the resin particle dispersion 1 described later.

TABLE 1

| Aqueous water-soluble resin | | | | | |
|---|---|---|---|---|---|
| solution no. | | 1 | 2 | 3 | 4 |
| Water- | Resin type | Styrene-butyl acrylate-acrylic acid | | | |
| soluble | | copolymer | | | |
| resin | Acid value | 121 | 88 | 65 | 130 |
| | [mg KOH/g] | | | | |
| | Weight average | 7,000 | 8,000 | 8,300 | 7,000 |
| | molecular weight | | | | |
| Formulation | Solid content | 20 | 20 | 20 | 6 |
| of aqueous | [%] | | | | |
| solution | 2-Pyrrolidone | | 20 | 20 | |
| | [%] | | | | |

| | |
|---|---|
| Neutralizer | Potassium hydroxide |

* Units of solid content and 2-pyrrolidone are % by mass.

Preparation of Resin Particle Dispersion

Preparation of Resin Particle Dispersion 1

As the resin particles to be added to inks, the resin particle dispersion 1 shown below was used. First, 18 parts of ethyl methacrylate, 2 parts of 2,2′-azobis-(2-methylbutyronitrile), and 2 parts of n-hexadecane were mixed, and the mixture was stirred for 0.5 hour. The mixture was added dropwise to 78 parts of the aqueous water-soluble resin solution 4 shown in Table 1, and the resulting mixture was stirred for 0.5 hour. Next, the mixture was sonicated with a sonicator for 3 hours. Subsequently, the mixture was polymerized under a nitrogen atmosphere at 80° C. for 4 hours. The reaction solution was cooled to room temperature and then filtered, giving a resin particle dispersion 1 having a resin particle content of 40.0% by mass. The resin constituting the resin particles had a weight average molecular weight of 250,000, and the resin particles had an average particle diameter (D₅₀) of 200 nm.

Preparation of Pigment Dispersion

Preparation of Black Pigment Dispersion Liquid

First, 10.0 parts of carbon black (product name: Monarch 1100, manufactured by Cabot), 15.0 parts of an aqueous resin solution 5, and 75.0 parts of ion-exchanged water were mixed. The aqueous resin solution 5 was prepared by neutralizing an aqueous solution of a styrene-ethyl acrylate-acrylic acid copolymer having an acid value of 150 and a weight average molecular weight of 8,000 in a resin content of 20.0% by mass with an aqueous potassium hydroxide solution. The mixture was put in a batch type vertical sand mill (manufactured by Aimex Co.), and then 200 parts of 0.3-mm zirconia beads were put. The mixture was dispersed for 5 hours while being cooled with water. The dispersion liquid was centrifuged to remove coarse particles, giving a black pigment dispersion having a pigment content of 10.0% by mass.

Preparation of Cyan Pigment Dispersion and Magenta Pigment Dispersion

A cyan pigment dispersion and a magenta pigment dispersion each having a pigment content of 10.0% were prepared in the same manner as for the black pigment dispersion except that the pigment type was changed as shown in Table 2.

TABLE 2

| | Bk pigment | C pigment | M pigment |
|---|---|---|---|
| Pigment dispersion | dispersion | dispersion | dispersion |
| Carbon black | 10.0 | | |
| C.I. Pigment Blue 15:3 | | 10.0 | |
| C.I. Pigment Red 122 | | | 10.0 |
| Aqueous water-soluble | 15.0 | 15.0 | 15.0 |
| resin solution 5 | | | |
| Ion-exchanged water | 75.0 | 75.0 | 75.0 |

* The units oil all the numerical values are % by mass.

Preparation of Ink

Preparation of Black Ink

The black pigment dispersion, the resin particle dispersion, a water-soluble resin, a surfactant, glycerin (GLY), polyethylene glycol (PEG) having a number average molecular weight of 1,000, and ion-exchanged water were thoroughly stirred and mixed. The mixture was subjected to pressure filtration through a microfilter with a pore size of 3.0 μm (manufactured by Fujifilm Co.), giving black inks (Bk1 to Bk18) containing the components at the proportions shown in Table 3-1 and Table 3-2. In Table 3-1 and Table 3-2, the “remainder” of ion-exchanged water is such an amount that the total amount of all the components constituting the ink becomes 100.0% by mass. The surfactants 1 to 6 are specifically shown in Table 4.

TABLE 3-1

| Bk ink no. | 1 | 2 | 3 | 4 | 5 | 6 | 7 | 8 | 9 |
|---|---|---|---|---|---|---|---|---|---|
| Bk pigment | 40.0 | 40.0 | 40.0 | 40.0 | 40.0 | 40.0 | 40.0 | 40.0 | 40.0 |
| dispersion | | | | | | | | | |
| Resin particle | 12.5 | 12.5 | 12.5 | 12.5 | 12.5 | 12.5 | 12.5 | 12.5 | 12.5 |
| dispersion | | | | | | | | | |
| Water-soluble | 14.0 | 14.0 | 14.0 | 14.0 | | | 14.0 | | 18.5 |
| resin 1 | | | | | | | | | |
| (acid value: 121) | | | | | | | | | |
| Water-soluble | | | | | 14.0 | | | 5.0 | |
| resin 2 | | | | | | | | | |
| (acid value: 88) | | | | | | | | | |
| Water-soluble | | | | | | 14.0 | | | |
| resin 3 | | | | | | | | | |
| (acid value: 65) | | | | | | | | | |
| Surfactant 1 | 1.0 | | 2.0 | | 2.0 | 2.0 | | 7.0 | 1.0 |
| Surfactant 2 | | 1.0 | | 2.0 | | | | | |
| Surfactant 3 | | | | | | | 1.0 | | |
| Surfactant 4 | | | | | | | | | |
| Surfactant 5 | | | | | | | | | |
| Surfactant 6 | | | | | | | | | |
| GLY | 7.0 | 7.0 | 7.0 | 7.0 | 7.0 | 7.0 | 7.0 | 7.0 | 7.0 |
| PEG | 3.0 | 3.0 | 3.0 | 3.0 | 3.0 | 3.0 | 3.0 | 3.0 | 3.0 |
| Ion-exchanged | Remainder | Remainder | Remainder | Remainder | Remainder | Remainder | Remainder | Remainder | Remainder |
| water | | | | | | | | | |
| Water-soluble | 1.2 | 1.2 | 1.2 | 1.2 | 1.2 | 1.2 | 1.2 | 1.2 | 1.2 |
| resin in pigment | | | | | | | | | |
| dispersion | | | | | | | | | |
| Water-soluble | 4.0 | 4.0 | 2.0 | 2.0 | 2.0 | 2.0 | 4.0 | 0.33 | 4.90 |
| resin/surfactant | | | | | | | | | |

* The water-soluble resin/surfactant is expressed in terms of mass ratio. The units of the other numerical values are % by mass.

TABLE 3-2

| Bk ink no. | 10 | 11 | 12 | 13 | 14 | 15 | 16 | 17 | 18 |
|---|---|---|---|---|---|---|---|---|---|
| Bk pigment | 40.0 | 40.0 | 40.0 | 40.0 | 40.0 | 40.0 | 40.0 | 40.0 | 40.0 |
| dispersion | | | | | | | | | |
| Resin particle | 12.5 | 12.5 | 12.5 | 12.5 | 12.5 | 12.5 | 0 | 12.5 | 12.5 |
| dispersion | | | | | | | | | |
| Water-soluble | 14.0 | 14.0 | 14.0 | 14.0 | 4.0 | 20.0 | 14.0 | 14.0 | |
| resin 1 | | | | | | | | | |
| (acid value: 121) | | | | | | | | | |
| Water-soluble | | | | | | | | | |
| resin 2 | | | | | | | | | |
| (acid value: 88) | | | | | | | | | |
| Water-soluble | | | | | | | | | |
| resin 3 | | | | | | | | | |
| (acid value: 65) | | | | | | | | | |
| Surfactant 1 | | | | 0.9 | 7.0 | 1.0 | 1.0 | 8.3 | |
| Surfactant 2 | | | | | | | | | |
| Surfactant 3 | | | | | | | | | |
| Surfactant 4 | 1.0 | | | | | | | | 1.0 |
| Surfactant 5 | | 1.0 | | | | | | | |
| Surfactant 6 | | | 1.0 | | | | | | |
| GLY | 7.0 | 7.0 | 7.0 | 7.0 | 7.0 | 7.0 | 7.0 | 7.0 | 7.0 |
| PEG | 3.0 | 3.0 | 3.0 | 3.0 | 3.0 | 3.0 | 3.0 | 3.0 | 3.0 |
| Ion-exchanged | Remainder | Remainder | Remainder | Remainder | Remainder | Remainder | Remainder | Remainder | Remainder |
| water | | | | | | | | | |
| Water-soluble | 1.2 | 1.2 | 1.2 | 1.2 | 1.2 | 1.2 | 1.2 | 1.2 | 1.2 |
| resin in pigment | | | | | | | | | |
| dispersion | | | | | | | | | |
| Water-soluble | 4.0 | 4.0 | 4.0 | 4.44 | 0.29 | 5.2 | 4.0 | 0.48 | 1.2 |
| resin/surfactant | | | | | | | | | |

* The water-soluble resin/surfactant is expressed in terms of mass ratio. The units of the other numerical values are % by mass.

TABLE 4

| | | | | Carboxy |
|---|---|---|---|---|
| | | | | group |
| | Chemical name | Trade name | Supplier | number |
| Surfactant 1 | Potassium | — | — | 1 |
| | laurate | | | |
| Surfactant 2 | Potassium | — | — | 1 |
| | oleate | | | |
| Surfactant 3 | Dipotassium | LATEMUL | Kao | 2 |
| | alkenyl | ASK | | |
| | succinate | | | |
| Surfactant 4 | POE (10) | Acetylenol | Kawaken | 0 |
| | acetylene | E100 | Fine | |
| | glycol | | Chemicals | |
| Surfactant 5 | Polyoxyethylene | BC20 | Nikko | 0 |
| | cetyl ether | | Chemicals | |
| Surfactant 6 | Sodium dodecyl | — | — | 0 |
| | sulfate | | | |

Preparation of Cyan Ink and Magenta Ink

Each of cyan inks (C1 to C18) and magenta inks (M1 to M18) was prepared in the same manner as for the black inks 1 to 18 except that the type of the pigment dispersion was changed to the cyan pigment dispersion or the magenta pigment dispersion.

Preparation of Liquid Composition

Preparation of Liquid Composition 1

Glutaric acid, glycerin (GLY), a surfactant (Acetylenol E-100), and ion-exchanged water were thoroughly stirred and mixed. The mixture was subjected to pressure filtration through a microfilter with a pore size of 3.0 μm (manufactured by Fujifilm Co.), giving a liquid composition 1 containing the components at the proportions shown in Table 5.

Preparation of Liquid Composition 2

A liquid composition 2 was prepared in the same manner as for the liquid composition 1 except that the types and the amounts of the reactants were changed as shown in Table 5.

TABLE 5

| Liquid composition no. | 1 | 2 |
|---|---|---|
| Glutaric acid | 30.0 | |
| Potassium hydroxide | 5.0 | |
| Calcium nitrate tetrahydrate | | 30.0 |
| GLY | 5.0 | 5.0 |
| Acetylenol E-100 | 1.0 | 1.0 |
| Ion-exchanged water | 59.0 | 64.0 |

* The units of all the numerical values are % by mass.

Preparation of Clear Ink

Preparation of Clear Ink 1

The aqueous water-soluble resin solution 1, the surfactant 1, glycerin (GLY), polyethylene glycol (PEG) having a number average molecular weight of 1,000, and ion-exchanged water were thoroughly stirred and mixed. The mixture was subjected to pressure filtration through a microfilter with a pore size of 3.0 μm (manufactured by Fujifilm Co.), giving a clear ink 1 (CL1) containing the components at the proportions shown in Table 6. In Table 6, the “remainder” of ion-exchanged water is such an amount that the total amount of all the components constituting the clear ink becomes 100.0% by mass.

Preparation of Clear Inks 2 to 10

Clear inks 2 to 10 (CL2 to CL10) were prepared in the same manner as for the clear ink 1 except that the types and the amounts of the aqueous water-soluble resin solutions and the surfactants were changed as shown in Table 6.

TABLE 6

| CL ink no. | 1 | 2 | 3 | 4 | 5 | 6 | 7 | 8 | 9 | 10 |
|---|---|---|---|---|---|---|---|---|---|---|
| Water-soluble | 25.0 | 25.0 | 25.0 | 25.0 | | 10.0 | 24.5 | 25.0 | 25.0 | 25.0 |
| resin 1 | | | | | | | | | | |
| (acid value: 121) | | | | | | | | | | |
| Water-soluble | | | | | 25.0 | | | | | |
| resin 2 | | | | | | | | | | |
| (acid value: 88) | | | | | | | | | | |
| Water-soluble | | | | | | | | | | |
| resin 3 | | | | | | | | | | |
| (acid value: 65) | | | | | | | | | | |
| Surfactant 1 | 0.9 | 1.5 | | | 1.5 | 6.0 | 1.0 | | | |
| Surfactant 2 | | | 1.5 | | | | | | | |
| Surfactant 3 | | | | 1.5 | | | | | | |
| Surfactant 4 | | | | | | | | 1.5 | | |
| Surfactant 5 | | | | | | | | | 1.5 | |
| Surfactant 6 | | | | | | | | | | 1.5 |
| GLY | 7.0 | 7.0 | 7.0 | 7.0 | 7.0 | 7.0 | 7.0 | 7.0 | 7.0 | 7.0 |
| PEG | 3.0 | 3.0 | 3.0 | 3.0 | 3.0 | 3.0 | 3.0 | 3.0 | 3.0 | 3.0 |
| Ion-exchanged | Remainder | Remainder | Remainder | Remainder | Remainder | Remainder | Remainder | Remainder | Remainder | Remainder |
| water | | | | | | | | | | |

* The units of all the numerical values are % by mass.

Recording Medium

As the recording medium, a pearl coated paper and an intermediate transfer member were prepared. As the pearl coated paper, Pearl Coat manufactured by Mitsubishi Paper Mills Co. was used. As the intermediate transfer member, intermediate transfer members used for transfer ink jet recording were prepared. The intermediate transfer member is used in such a way that an image is once formed on a non-permeable medium and then the image is transferred to a coated paper, and has a two-layer structure including a supporting member and a surface layer member. As the supporting member, a flat plate made of an aluminum alloy was used. As the surface layer member, a hydrolyzable organic silicon compound was used as a raw material, and a surface layer composed of a siloxane compound was formed on the surface of the supporting member.

Evaluation of Image

The inks and the liquid compositions obtained in the above were filled in ink cartridges, and the cartridges were combined as shown in Table 7 and installed in an image recorder. First, the liquid composition obtained in the above was applied to a recording medium in a coating amount of 1.0 g/m² with a coating roller. To the recording medium coated with the liquid composition, the inks were then ejected from an ink jet recording head, and the resulting image was evaluated. The black ink, the cyan ink, and the magenta ink were applied so as to give an impact time difference of 0.1 second. Here, the liquid composition 2 was used only in Example 10, and the liquid composition 1 was used in the other examples and comparative examples. The intermediate transfer member was used as the recording medium only in Example 11, and coated paper (pearl coated paper) was used in the other examples and comparative examples.

For the image recorder, the condition in which 3.0 nanograms (ng) of an ink drop is applied to a unit area of 1/1,200 inch× 1/1,200 inch at a resolution of 1,200 dpi×1,200 dpi is defined as a recording duty of 100%. The applied amount of ink is 6.7 g/m² in the case of a duty of 100% and is 20 g/m² in the case of a duty of 300%.

In Example 12, the liquid composition was applied by ejecting it from a recording head. The liquid composition 1 was used and applied at a duty of 25%.

Evaluation

Variation in Dot Size

The image recording method was performed with a cyan ink to record a 100%-duty solid image in an area with dimensions of 5 cm×5 cm, and a black ink was further applied to an area recorded with the cyan ink and to an unrecorded area, giving images for evaluation. “Dot size 1” of the black ink in the area without the cyan ink and “dot size 2” of the black ink in the area with the cyan ink were determined, and “dot size ratio” was calculated in accordance with Expression (1). From the “dot size ratio” calculated, the “variation in dot size” was evaluated in accordance with the evaluation criteria shown below. The evaluation results are shown in Table 7.

Dot size ratio=|100−{(dot size 2/dot size 1)×100}| (1)

Evaluation Criteria for Variation in Dot Size

AA: An image had excellent quality with a dot size ratio of less than 5.
A: An image had good quality with a dot size ratio of not less than 5 and less than 10.
B: An image had a dot size ratio of not less than 10 and less than 20, which exhibited a difference in the dot size but was usable.
C: An image was unable to be recorded with a dot size ratio of 20 or more.

Image Shift

The image recording method was performed with a cyan ink, a magenta ink, and a black ink to record a 300%-duty solid image in an area with dimensions of 5 cm×5 cm. The recorded solid image was observed under a microscope, and the degree of “image shifts” was evaluated in accordance with the evaluation criteria shown below. The evaluation results are shown in Table 7.

Evaluation Criteria for Image Shift

AA: An excellent solid image with no color skip area was recorded.
A: The area proportion of color skip area was not less than 1% and less than 5%, and a good solid image was recorded.
B: The area proportion of color skip area was not less than 5% and less than 10%, and an acceptable solid image was recorded while a color skip area was partially observed.
C: A color skip area was observed, and any acceptable solid image was unable to be recorded.

Gloss, Image Cracks, and Smeared Images

The image recording method was performed with a cyan ink, a magenta ink, and a black ink to record a 100%-duty solid image in an area with dimensions of 5 cm×5 cm, a 200%-duty solid image in an area with dimensions of 5 cm×5 cm, and a 300%-duty solid image in an area with dimensions of 5 cm×5 cm. The clear ink was further ejected at a duty of 200% onto the images formed with the inks, giving images for evaluation. The evaluation images were observed, and the degrees of “gloss”, “image cracks”, and “smeared images” were evaluated in accordance with the evaluation criteria shown below. The evaluation results are shown in Table 8.

Evaluation Criteria for Gloss

A: A good image without gloss unevenness was recorded.
B: An image had some gloss unevenness but was usable.
C: An image had marked gloss unevenness and unusable.

Evaluation Criteria for Image Crack

Solid image conditions were observed under a microscope and evaluated.

AA: An excellent solid image with no image crack was recorded.
A: The area proportion of image cracked part was not less than 1% and less than 5%, and a good solid image was recorded.
B: The area proportion of image cracked part was not less than 5% and less than 10%, and an acceptable solid image was recorded while a color skip area was partially observed.
C: Image cracks were observed, and no solid image was able to be recorded.

Evaluation Criteria for Smeared Image

AA: An excellent image with no smeared image was recorded.
A: A good image with almost no smeared image was recorded.
B: A partially smeared but usable image was recorded.
C: A markedly smeared, unusable image was recorded.

TABLE 7

| | | | | | Liquid | | | |
|---|---|---|---|---|---|---|---|---|
| | Combination | | | | composition | | Evaluation | |
| | Bk ink | C ink | M ink | Liquid | application | Recording | Image | Variation |
| | no. | no. | no. | composition | means | medium | shift | in dot size |
| Example 1 | Bk1 | C1 | M1 | Liquid | Roller | Coated paper | B | B |
| | | | | composition 1 | | | | |
| Example 2 | Bk2 | C2 | M2 | Liquid | Roller | Coated paper | B | B |
| | | | | composition 1 | | | | |
| Example 3 | Bk3 | C3 | M3 | Liquid | Roller | Coated paper | A | B |
| | | | | composition 1 | | | | |
| Example 4 | Bk4 | C4 | M4 | Liquid | Roller | Coated paper | A | B |
| | | | | composition 1 | | | | |
| Example 5 | Bk5 | C5 | M5 | Liquid | Roller | Coated paper | A | A |
| | | | | composition 1 | | | | |
| Example 6 | Bk6 | C6 | M6 | Liquid | Roller | Coated paper | A | AA |
| | | | | composition 1 | | | | |
| Example 7 | Bk7 | C7 | M7 | Liquid | Roller | Coated paper | AA | AA |
| | | | | composition 1 | | | | |
| Example 8 | Bk8 | C8 | M8 | Liquid | Roller | Coated paper | B | B |
| | | | | composition 1 | | | | |
| Example 9 | Bk9 | C9 | M9 | Liquid | Roller | Coated paper | A | B |
| | | | | composition 1 | | | | |
| Example 10 | Bk3 | C3 | M3 | Liquid | Roller | Coated paper | B | B |
| | | | | composition 2 | | | | |
| Example 11 | Bk3 | C3 | M3 | Liquid | Roller | Intermediate | A | B |
| | | | | composition 1 | | transfer member | | |
| Example 12 | Bk3 | C3 | M3 | Liquid | Recording | Coated paper | A | B |
| | | | | composition 1 | head | | | |
| Comparative | Bk10 | C10 | M10 | Liquid | Roller | Coated paper | C | B |
| Example 1 | | | | composition 1 | | | | |
| Comparative | Bk11 | C11 | M11 | Liquid | Roller | Coated paper | B | C |
| Example 2 | | | | composition 1 | | | | |
| Comparative | Bk12 | C12 | M12 | Liquid | Roller | Coated paper | B | C |
| Example 3 | | | | composition 1 | | | | |
| Comparative | Bk13 | C13 | M13 | Liquid | Roller | Coated paper | C | B |
| Example 4 | | | | composition 1 | | | | |
| Comparative | Bk14 | C14 | M14 | Liquid | Roller | Coated paper | B | C |
| Example 5 | | | | composition 1 | | | | |
| Comparative | Bk15 | C15 | M15 | Liquid | Roller | Coated paper | C | B |
| Example 6 | | | | composition 1 | | | | |
| Comparative | Bk16 | C16 | M16 | Liquid | Roller | Coated paper | C | C |
| Example 7 | | | | composition 1 | | | | |
| Comparative | Bk17 | C17 | M17 | Liquid | Roller | Coated paper | B | C |
| Example 8 | | | | composition 1 | | | | |

TABLE 8

| | | | | | | Liquid | | | | |
|---|---|---|---|---|---|---|---|---|---|---|
| | Combination | | | | | composition | | Evaluation | | |
| | Bk ink | C ink | M ink | CL ink | Liquid | application | Recording | | Image | Smeared |
| | no. | no. | no. | no. | composition | means | medium | Gloss | crack | image |
| Example 13 | Bk18 | C18 | M18 | CL1 | Liquid | Roller | Coated paper | A | B | A |
| | | | | | composition 1 | | | | | |
| Example 14 | Bk18 | C18 | M18 | CL2 | Liquid | Roller | Coated paper | A | A | A |
| | | | | | composition 1 | | | | | |
| Example 15 | Bk18 | C18 | M18 | CL3 | Liquid | Roller | Coated paper | A | A | A |
| | | | | | composition 1 | | | | | |
| Example 16 | Bk18 | C18 | M18 | CL4 | Liquid | Roller | Coated paper | A | AA | A |
| | | | | | composition 1 | | | | | |
| Example 17 | Bk18 | C18 | M18 | CL5 | Liquid | Roller | Coated paper | A | AA | A |
| | | | | | composition 1 | | | | | |
| Example 18 | Bk18 | C18 | M18 | CL6 | Liquid | Roller | Coated paper | A | A | A |
| | | | | | composition 1 | | | | | |
| Example 19 | Bk18 | C18 | M18 | CL7 | Liquid | Roller | Coated paper | A | A | A |
| | | | | | composition 1 | | | | | |
| Example 20 | Bk1 | C1 | M1 | CL2 | Liquid | Roller | Coated paper | A | AA | A |
| | | | | | composition 1 | | | | | |
| Comparative | Bk18 | C18 | M18 | CL8 | Liquid | Roller | Coated paper | C | C | A |
| Example 9 | | | | | composition 1 | | | | | |
| Comparative | Bk18 | C18 | M18 | CL9 | Liquid | Roller | Coated paper | A | B | C |
| Example 10 | | | | | composition 1 | | | | | |
| Comparative | Bk18 | C18 | M18 | CL10 | Liquid | Roller | Coated paper | A | B | C |
| Example 11 | | | | | composition 1 | | | | | |

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-188875, filed Sep. 17, 2014, which is hereby incorporated by reference herein in its entirety.

What is claimed is:

1. An image recording method comprising:
a step (A) of applying an ink containing a coloring material to a recording medium; and
a step (B) of applying a liquid composition to the recording medium so as to at least partially overlap with an area where the ink is applied, the liquid composition causing viscosity increase when mixed with the ink,
wherein the ink contains resin particles, an anionic water-soluble resin, and an anionic surfactant having a carboxy group,
wherein a content of the surfactant in the ink is 1% by mass or more and 8% by mass or less based on a total mass of the ink, and
wherein a mass ratio of a content of the water-soluble resin to the content of the surfactant in the ink is 0.3 times or more and 5.0 times or less.

2. The image recording method according to claim 1, wherein the content of the surfactant in the ink is 2% by mass or more and 8% by mass or less based on the total mass of the ink.

3. The image recording method according to claim 1, wherein the water-soluble resin contains a constituent unit derived from an unsaturated carboxylic acid and has an acid value of 40 mg KOH/g or more and 90 mg KOH/g or less.

4. The image recording method according to claim 1, wherein the water-soluble resin contains a constituent unit derived from an unsaturated carboxylic acid and has an acid value of 40 mg KOH/g or more and 70 mg KOH/g or less.

5. The image recording method according to claim 1, wherein the surfactant is an anionic surfactant having a plurality of carboxy groups.

6. An ink set comprising:
an ink containing a coloring material; and
a liquid composition causing viscosity increase when mixed with the ink,
wherein the ink contains resin particles, an anionic water-soluble resin, and an anionic surfactant having a carboxy group,
wherein a content of the surfactant in the ink is 1% by mass or more and 8% by mass or less based on a total mass of the ink, and
wherein a mass ratio of a content of the water-soluble resin to the content of the surfactant in the ink is 0.3 times or more and 5.0 times or less.

7. An image recording method comprising:
a step (A) of applying an ink containing a coloring material to a recording medium;
a step (B) of applying a liquid composition to the recording medium so as to at least partially overlap with an area where the ink is applied, the liquid composition causing viscosity increase when mixed with the ink; and
a step (C) of applying a clear ink containing no coloring material to the recording medium so as to at least partially overlap with an area where the liquid composition is applied,
wherein the clear ink contains an anionic water-soluble resin and an anionic surfactant having a carboxy group.

8. The image recording method according to claim 7, wherein a content of the surfactant in the clear ink is 1% by mass or more and 8% by mass or less based on a total mass of the clear ink, and a mass ratio of a content of the water-soluble resin to the content of the surfactant in the clear ink is 0.3 times or more and 10.0 times or less.

9. An ink set comprising:
an ink containing a coloring material;
a clear ink containing no coloring material; and
a liquid composition causing viscosity increase when mixed with the ink and the clear ink,
wherein the clear ink contains an anionic water-soluble resin and an anionic surfactant having a carboxy group.
